(19) United States
(12) Patent Application Publication
(10) Pub. No.: US 2015/0239537 A1
(43) Pub. Date: Aug. 27, 2015

(54) Snorkel Apparatus

(71) Applicant: Max Peter Calvillo, Saugus, CA (US)

(72) Inventor: Max Peter Calvillo, Saugus, CA (US)

(21) Appl. No.: 14/192,187

(22) Filed: Feb. 27, 2014

(51) Int. Cl. B63C 11/20; H04R 1/44; H04R 1/10; B63C 11/18

(52) U.S. Cl. CPC B63C 11/205; B63C 11/186; H04R 1/44; H04R 1/1016

(57) ABSTRACT

A snorkeling device that permits the user to expeditiously initiate and continue freestyle, butterfly, breaststroke and crawl swimming strokes while listening to audio and without having to repeatedly tilt the body, or turn the head and without having water enter the top inlet of the device.

### CROSS-REFERENCE TO RELATED APPLICATIONS: Not Applicable

STATEMENT REGARDING FEDERALLY SPONSORED RESEARCH OR DEVELOPMENT: Not Applicable

### INCORPORATION-BY-REFERENCE OF MATERIAL SUBMITTED ON A

### COMPACT DISC: Not Applicable

### BACKGROUND OF THE INVENTION

1. Field of the Invention

The present invention relates generally to swimming devices. More particularly the invention concerns a novel snorkeling device of unique design that permits the user to expeditiously initiate and continue freestyle, butterfly, breaststroke and crawl swimming strokes without having to repeatedly tilt the body, or turn the head and without having water enter the top inlet of the device.

2. Description of Related Art Including Information Disclosed Under 37 CRF 1.97 and 1.98

Snorkeling involves the technique of swimming with a diving mask and an elongate tube generally referred to as a snorkel. The conventional snorkel tube is typically about 30 to 40 centimeters long and has an inside diameter of between about 1.5 and 2.5 centimeters. The inboard, generally J-shaped end of the snorkel is fitted with a mouthpiece that can be inserted into the user's mouth so as to permit the user to breath air from above the water surface when the mouth and nose are submerged. Snorkelers normally wear a tight fitting diving mask that includes a faceplate, a pliable skirt that fits over the face and a head strap that securely holds the mask in position.

In recent years, the sport of snorkeling has become quite popular since it permits the snorkeler to relatively effortlessly view a variety of submerged objects such as underwater structures and swimming fish. Use of the snorkeling device is relatively simple and when the snorkeler returns to the to the surface, water is expelled from the snorkel by blowing air through the snorkel to or by tilting the head back shortly before reaching the surface and exhaling.

While the conventional snorkel apparatus is useful for recreational purposes and for short distance swimming, the somewhat cumbersome, loose fitting construction of the apparatus makes it impractical for steady swimming for purposes of routine exercise. The cumbersome design of the conventional snorkel apparatus creates substantial drag in the water and the need for the user to tilt the head or body to inhale or exhale is not conducive to the use of the apparatus for routine exercise swimming using conventional crawl and the like swimming strokes. It is this drawback that the apparatus of the present invention seeks to overcome.

The device of the invention is a unique design that permits the user to expeditiously initiate and continue freestyle, butterfly, breaststroke and crawl swimming strokes without having to repeatedly tilt the body, or turn the head and without having water enter the top inlet of the device. This novel feature of the invention enhances the exercise experience and maximizes the benefits derived there from.

### BRIEF SUMMARY OF THE INVENTION

It is an object of the present invention to provide a novel snorkel apparatus that is ideally suited for exercise swimming because, due to its unique design, the swimmer can initiate and continue crawl and the like swimming strokes and breathe freely without having to repeatedly tilt the body, or turn the head.

Another object of the invention is to provide a novel snorkeling apparatus of the aforementioned character in which the breathing and air inlet tubes of the apparatus are specially shaped so as to substantially reduce drag as the swimmer moves through the water.

Another object of the invention is to provide a snorkeling apparatus of the character described in the preceding paragraphs that includes a built in, waterproof digital audio player that permits the swimmer to listen to audio recordings, such as music and the like during the exercise regimen.

Another object of the invention is to provide a snorkeling apparatus that includes an upwardly extending, generally straight air inlet tube that is adjustable in length.

Another object of the invention is to provide a snorkeling apparatus of the class described that is of simple construction, is easy to don and is comfortable to wear while performing swimming exercises.

Another object of the invention is to provide a snorkeling apparatus of the aforementioned character that is provided with two drain ports.

Another object of the invention is to provide a snorkeling apparatus that is highly reliable in operation and can be inexpensively manufactured.

It will become apparent that these and other objects of the invention can be realized through use of the novel snorkel apparatus illustrated in the drawings and described in the specification that follows.

### BRIEF DESCRIPTION OF SEVERAL VIEWS OF THE DRAWINGS

FIG. 1 is a top plan view of one form of the snorkel apparatus of the invention.

FIG. 2 is a cross-sectional view taken along lines 2-2 of FIG. 1.

FIG. 3 is a view taken along lines 3-3 of FIG. 1.

FIG. 4 is a side elevational view of the form of the snorkel apparatus of the invention shown in FIG. 1.

FIG. 4A is a cross-sectional view taken along lines 4A-4A of FIG. 4.

FIG. 5 is a cross-sectional view taken along lines 5-5 of FIG. 4 showing the details of construction of one side of the apparatus, the other side of the apparatus being of substantially identical construction.

FIG. 6 is a generally perspective, illustrative view showing the snorkel apparatus of the invention as it appears when being used by a swimmer.

FIG. 7 is a left side elevational, illustrative view showing the snorkel apparatus of the invention as it appears when affixed to the head of a swimmer.

FIG. 8 is a fragmentary, exploded, side elevational view of an alternate form of the air inlet tube of the snorkel apparatus.

FIG. 9 is a right side elevational, illustrative view showing the snorkel apparatus of the invention as it appears when affixed to the head of a swimmer.

### DETAILED DESCRIPTION OF THE INVENTION

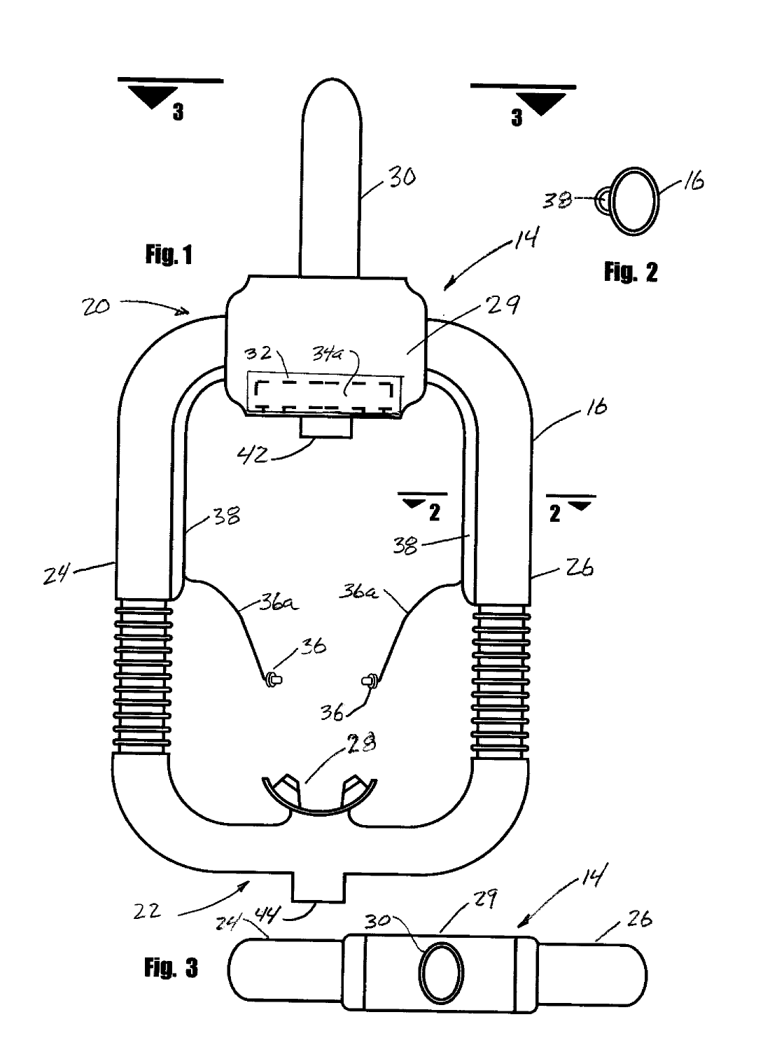

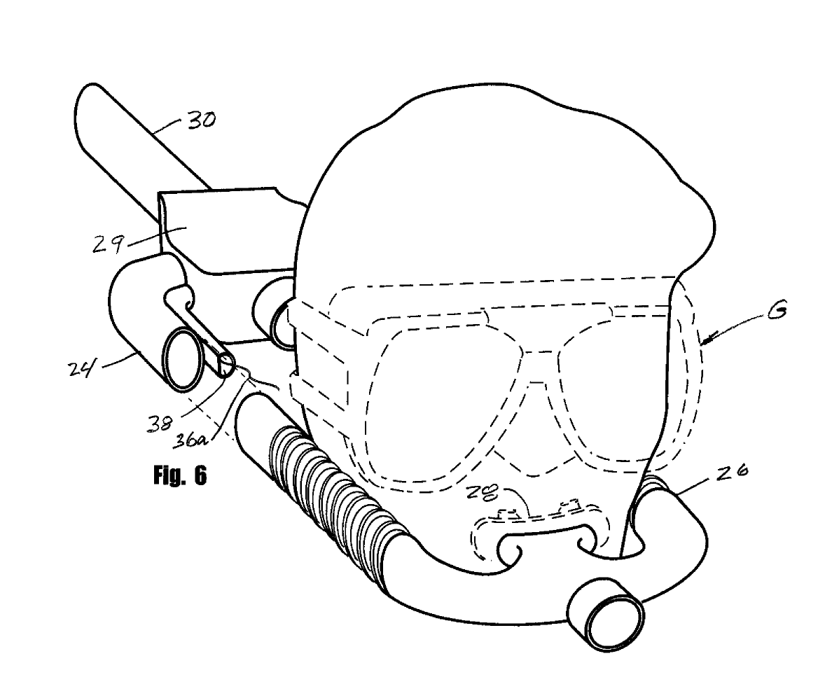

Referring to the drawings and particularly to FIGS. 1 through 7, one form of the novel snorkel apparatus of the invention is there shown and generally designated by the numeral 14. Snorkel apparatus 14 here comprises a generally oval shaped tubular member 16 having an internal breathing passageway 18 (FIG. 5), an upper portion 20, a lower portion 22 and first and second side portions 24 and 26 respectively. Connected to hollow breathing tube 16 proximate the lower portion thereof is a mouthpiece 28 that is adapted to be received in the swimmer's mouth and gripped by the swimmer's teeth. Mouthpiece 28 has a mouthpiece breathing passageway 28a that is in communication with breathing passageway 18 of tubular member 16 (see FIG. 5).

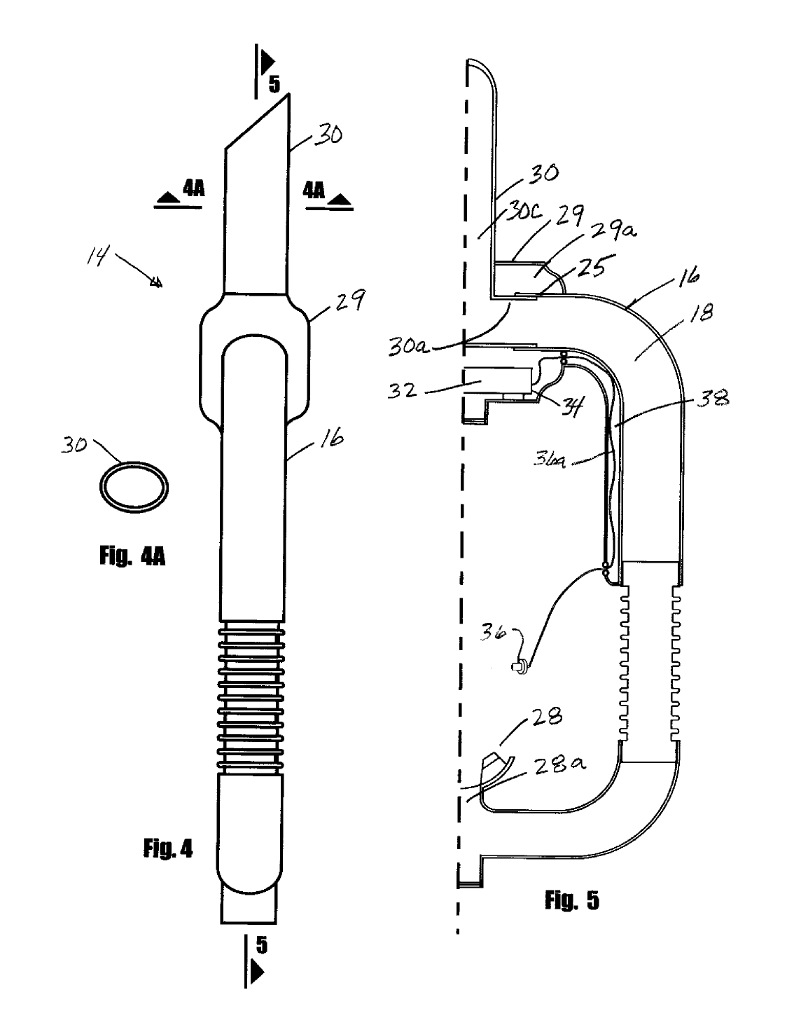

Connected to the upper portion of the tubular member 16 is a chamber defining housing 29 having an internal chamber 29a. As indicated in FIG. 5 of the drawings, the upper extremities 25 of the first and second side portions 24 and 26 extend into internal chamber 29a and are interconnected with a specially configured air inlet tube 30 (see FIGS. 1 and 2). More particularly, air inlet tube 30 includes a pair of outwardly extending arms 30a that are disposed within the chamber defining housing 29 and are connected to the upper extremities 25 of the first and second side portions of the tubular member. With this construction, the air inlet passageway 30c of the air inlet tube is in open communication with breathing passageway 18 of tubular member 16. As best seen in FIG. 4A of the drawings, the upper portion of the air inlet tube 30 is generally elliptical in cross-section so that it can cleanly cut through the water as the swimmer moves forwardly. Similarly, the generally elliptical cross-section of tubular member 16 enables it to cleanly cut through the water as the swimmer moves forwardly (see FIG. 2).

A unique feature of the snorkel apparatus of the present invention resides in the provision of a waterproof digital audio player that permits the swimmer to listen to various audio recordings, such as music, while swimming. This digital audio player, which is identified in the drawings by the numeral 32, is readily available from several sources including a device manufactured by Apple, Inc. of Cupertino, Calif. and marketed under the name and style “iPod shuffle”. In the present form of the invention, the digital audio player is mounted within a music device chamber 34 that is disposed within the upper hollow chamber defining housing (FIGS. 1 and 5). If it is desired to use a digital audio player that is not waterproof, music device chamber 34 can, in a manner well understood by those skilled in the art, be constructed to be substantially waterproof. The digital audio player can be inserted and removed from chamber 34 via a suitably located access panel, such as panel 34a (see FIG. 1)

Operably associated with the digital audio player is a pair of conventional earplug speakers 36 that are also readily commercially available from several sources, including Apple Inc.. Earplug speakers 36 are interconnected with the digital audio player by a pair of conventional connector wires 36a that are entrained through connector wire channels 38 formed proximate the sides of the hollow breathing tube 16 (see FIGS. 1 and 5). If desired, the connector wires 36a can be located inside the breathing passageway 18.

To enable the hollow breathing tube 16 to be secured to the head of the user, an adjustable strap assembly 40 is provided. Strap assembly 40 is of conventional construction and is interconnected with the tubular member 16 in the manner illustrated in the drawings. More particularly, strap assembly 40 here comprises a pair of angularly extending straps 40a the extremities of which are interconnected by suitable snap connectors 40b.

In using the snorkel apparatus of the invention, the mouthpiece 28 is inserted into the swimmer's mouth and is gripped by the swimmer's teeth. This done, the breathing tube 16 is then appropriately positioned about the head of the swimmer in the manner shown in the drawings and the apparatus is secured in position in a conventional manner using the adjustable strap assembly 40. With this arrangement, the swimmer can look directly forwardly through suitable goggles “G” and swim through the water using conventional swimming strokes.

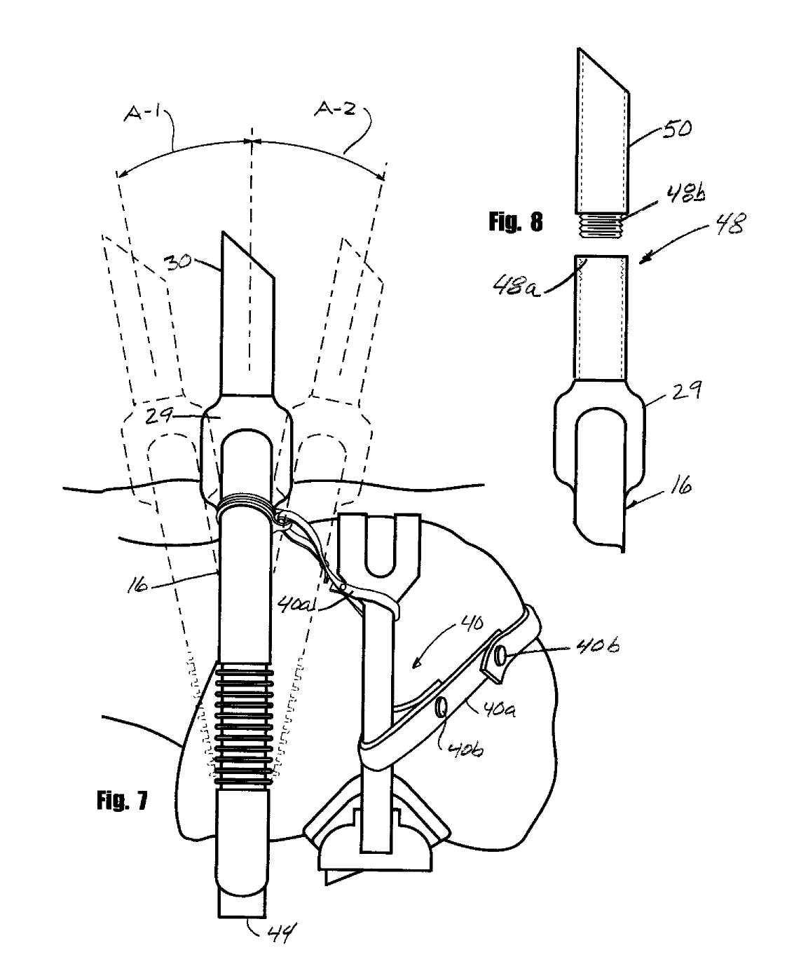

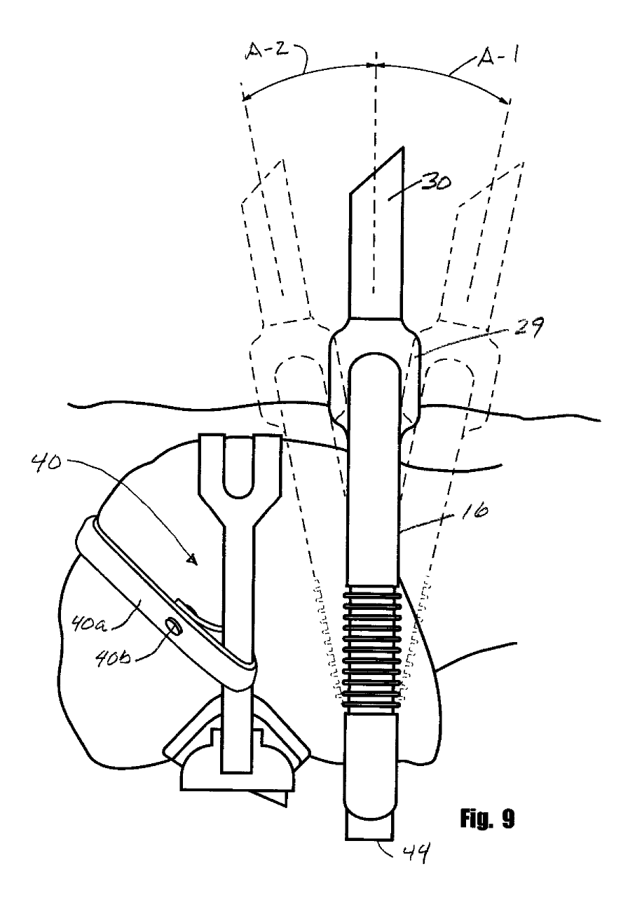

As the swimmer swims forwardly, the buoyant chamber defining housing 29 assists in maintaining the inlet of the air inlet tube 30 above the surface of the water and, as depicted in FIGS. 7 and 9 of the drawings, permits the air inlet tube to swing backwardly and forwardly through arcs A-1 and A-2 respectively.

Since the upper end 30b of the air inlet tube 30 extends above the surface of the water as the swimmer moves forwardly, the swimmer can freely breathe through the air inlet passageway 30a without having to tilt his or her head.

During the swimming exercise, any water that enters the breathing tube 16, as through the upper end of the air inlet tube, will drain from the breathing tube via the first drain 42 that is disposed proximate the upper portion 20 of the breathing tube, or alternatively through the second drain 44 that is disposed proximate the lower portion 22 of the breathing tube (see FIG. 1).

As illustrated in FIG. 8 of the drawings, in an alternate form of the snorkel apparatus of the invention, the upwardly extending, generally straight air inlet tube is adjustable in length. More particularly, in this alternate form of the invention, the upper end 48a of the air inlet tube 48 is provided with threads so that, if desired, an externally threaded extension 50 can be interconnected with the air inlet tube 48 to effectively increase the overall length of the air inlet tube.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

1. A snorkel apparatus for use by a swimmer comprising:
(a) a tubular member having a breathing passageway, an upper portion, a lower portion and first and second side portions;
(b) a mouthpiece connected to said tubular member proximate said lower portion thereof, said mouthpiece having a mouthpiece breathing passageway in communication with said breathing passageway of said tubular member;
(c) a chamber defining housing connected to said upper portion of said tubular member; and
(d) an air inlet tube extending outwardly from said chamber defining housing, said air inlet tube having an air inlet passageway in communication with said breathing passageway of said tubular member and a being generally elliptical in cross-section;
whereby said mouthpiece may be held between the swimmer's teeth with the snorkel apparatus being positioned on the swimmer's head such that the first and second side portions thereof are disposed proximate the sides of the swimmer's face.

2. The snorkel apparatus as defined in claim 1 in which said tubular member is generally oval shaped.

3. The snorkel apparatus as defined in claim I in which said tubular member is generally elliptical in cross-section.

4. The snorkel apparatus as defined in claim 1 in which said air inlet tube includes a first arm disposed within said chamber defining housing and connected to said first side portion of said tubular member and a second arm disposed within said chamber defining housing and connected to said second side portion of said tubular member.

5. The snorkel apparatus as defined in claim 1 in which said chamber defining housing includes a first drain port and in which said lower portion of said tubular member includes a second drain port.

6. The snorkel apparatus as defined in claim 1 further including a strap assembly connected to said tubular member for circumscribing the swimmer's head.

7. A snorkel apparatus for use by a swimmer comprising:
(a) a tubular member having a breathing passageway, an upper portion, a lower portion and first and second side portions;
(b) a mouthpiece connected to said tubular member proximate said lower portion thereof, said mouthpiece having a mouthpiece breathing passageway in communication with said breathing passageway of said tubular member;
(c) a chamber defining housing connected to said upper portion of said tubular member;
(d) an air inlet tube extending outwardly from said chamber defining housing, said air inlet tube having an air inlet passageway in communication with said breathing passageway of said tubular member; and
(e) a music playing device disposed within said chamber defining housing.

8. The snorkel apparatus as defined in claim 7 further including earplug speakers carried by said tubular member and interconnected with said music playing device.

9. The snorkel apparatus as defined in claim 7 in which said music playing device is waterproof.

10. The snorkel apparatus as defined in claim 7 in which said air inlet tube includes a first arm disposed within said chamber defining housing and connected to said first side portion of said tubular member and a second arm disposed within said chamber defining housing and connected to said second side portion of said tubular member.

11. The snorkel apparatus as defined in claim 7 further including a strap assembly connected to said tubular member for circumscribing the swimmer's head.

12. The snorkel apparatus as defined in claim 7 in which said tubular member includes a drain port.

13. The snorkel apparatus as defined in claim 7 in which said chamber defining housing includes a first drain port and in which said lower portion of said tubular member includes a second drain port.

14. The snorkel apparatus as defined in claim 7 in which said tubular member is generally elliptical in cross-section.

15. A snorkel apparatus for use by a swimmer comprising:
(a) a tubular member having a breathing passageway, an upper portion, a lower portion and first and second side portions;
(b) a mouthpiece connected to said tubular member proximate said lower portion thereof, said mouthpiece having a mouthpiece breathing passageway in communication with said breathing passageway of said tubular member;
(c) a chamber defining housing connected to said upper portion of said tubular member;
(d) an air inlet tube connected to said chamber defining housing, said air inlet tube having a first arm disposed within said chamber defining housing and connected to said first side portion of said tubular member and a second arm disposed within said chamber defining housing and connected to said second side portion of said tubular member;
(e) a music playing device disposed within said chamber defining housing; and
(f) a pair of earplug speakers carried by said tubular member and interconnected with said music playing device.

16. The snorkel apparatus as defined in claim 15 in which said music playing device is waterproof.

17. The snorkel apparatus as defined in claim 15 in which said air inlet tube includes an elongated, substantially straight first section extending outwardly from said chamber defining housing and a second section removably interconnected with said first section.

18. The snorkel apparatus as defined in claim 15 further including a strap assembly connected to said tubular member for circumscribing the swimmer's head.

19. The snorkel apparatus as defined in claim 15 in which said tubular member is generally elliptical in shape.

20. The snorkel apparatus as defined in claim 15 in which said chamber defining housing includes a first drain port and in which said lower portion of said tubular member includes a second drain port.
